(19) United States
(12) Patent Application Publication
(10) Pub. No.: US 2022/0063225 A1
(43) Pub. Date: Mar. 3, 2022

(54) METHOD AND APPARATUS FOR MEASURING RADIAL FORCE DURING TIRE BUILDING

(71) Applicant: The Goodyear Tire & Rubber Company, Akron, OH (US)

(72) Inventors: Marie Isabelle Deuil, Amiens (FR); Fabien Cotte, Pernois (FR); Dany Gambier, Argoeuves (FR); Jean-Francois Legros, Amiens (FR); Colomban Huet De Froberville, Paris 17 (FR); Gregory Rullé, Amiens (FR)

(21) Appl. No.: 17/332,257

(22) Filed: May 27, 2021

Related U.S. Application Data
(60) Provisional application No. 63/071,658, filed on Aug. 28, 2020.

(51) Int. Cl. B29D 30/58

(52) U.S. Cl. CPC B29D 30/58

(57) ABSTRACT

A method and apparatus for determining the force variation on a green tire, the method comprising the steps of: forming a green tire having a tread and belt assembly, stitching the outer surface of the tread using a pressure roller and measuring the radial force by a sensor mounted in the pressure roller.

### FIELD OF THE INVENTION

The invention relates generally to a method for measuring radial force during the formation of a green tire and, more specifically, to a method for measuring and controlling the formation of a green tire during component by component tire build-up in order to attain desired finished tire geometry and uniformity.

### BACKGROUND OF THE INVENTION

It is a desired objective in tire manufacturing to carefully control the formation of a pre-cured or green tire so as to reduce tire imbalance and maximize tire uniformity. Prior art measurements of tire balance and uniformity are typically made after the tire has been cured to ensure the tire has met acceptable quality specifications and parameters. Tires that do not meet preset specifications relating to uniformity and geometry are typically scrapped, resulting in costly waste.

Thus, it is desired to have an improved way of measuring tire nonuniformity, such as radial force variation in order to improve the tire building process and to measure the nonuniformity during the tire building process in real time, and to avoid the scrapping of tires.

### SUMMARY OF THE PRESENT INVENTION

A method of determining the force variation on a green tire is described. The method includes the steps of: forming a green tire having a tread and belt assembly, stitching the outer surface of the tread using a pressure roller and measuring the radial force by a sensor mounted in the pressure roller.

An apparatus for building tires and measuring the force variation on a green tire is described. The apparatus includes a tire building drum, and a stitching device, wherein the stitching device includes a pressure roller rotatably mounted in a first and second bearing located on each end of the pressure roller, and a first and second axle sensor, each axle sensor having a spindle mounted within a respective bearing for measuring the forces on the pressure roller.

### Definitions

“Aspect Ratio” means the ratio of a tire's section height to its section width.

“Axial” and “axially” means the lines or directions that are parallel to the axis of rotation of the tire.

“Bead” or “Bead Core” means generally that part of the tire comprising an annular tensile member, the radially inner beads are associated with holding the tire to the rim being wrapped by ply cords and shaped, with or without other reinforcement elements such as flippers, chippers, apexes or fillers, toe guards and chafers.

“Belt Structure” or “Reinforcing Belts” means at least two annular layers or plies of parallel cords, woven or unwoven, underlying the tread, unanchored to the bead, and having both left and right cord angles in the range from 17° to 27° with respect to the equatorial plane of the tire.

“Bias Ply Tire” means that the reinforcing cords in the carcass ply extend diagonally across the tire from bead-to-bead at about 25-65° angle with respect to the equatorial plane of the tire, the ply cords running at opposite angles in alternate layers.

“Breakers” or “Tire Breakers” means the same as belt or belt structure or reinforcement belts.

“Carcass” means a laminate of tire ply material and other tire components cut to length suitable for splicing, or already spliced, into a cylindrical or toroidal shape. Additional components may be added to the carcass prior to its being vulcanized to create the molded tire.

“Circumferential” means lines or directions extending along the perimeter of the surface of the annular tread perpendicular to the axial direction; it can also refer to the direction of the sets of adjacent circular curves whose radii define the axial curvature of the tread as viewed in cross section.

“Cord” means one of the reinforcement strands, including fibers, which are used to reinforce the plies.

“Inner Liner” means the layer or layers of elastomer or other material that form the inside surface of a tubeless tire and that contain the inflating fluid within the tire.

“Inserts” means the reinforcement typically used to reinforce the sidewalls of runflat-type tires; it also refers to the elastomeric insert that underlies the tread.

“Ply” means a cord-reinforced layer of elastomer-coated, radially deployed or otherwise parallel cords.

“Radial” and “radially” mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which the ply cords which extend from bead to bead are laid at cord angles between 65° and 90° with respect to the equatorial plane of the tire.

“Sidewall” means a portion of a tire between the tread and the bead.

“Laminate structure” means an unvulcanized structure made of one or more layers of tire or elastomer components such as the innerliner, sidewalls, and optional ply layer.

### BRIEF DESCRIPTION OF THE DRAWINGS

The invention will be described by way of example and with reference to the accompanying drawings in which:

FIG. 1 is a front view of a typical tire building machine;

FIG. 2 is a schematic side view of a tire drum and stitcher roller for stitching and radial force measurement operation performed on a green tire assembly mounted on a drum just after the tread has been applied;

FIG. 3 illustrates the radial force on a green tire assembly during rotation;

FIG. 4a illustrates a stitcher roller and sensor assembly, FIG. 4b illustrates a front view of the axle sensor assembly for measuring radial forces, and FIG. 4C illustrates a cross-sectional view of a stitcher roller and axle sensor assembly;

FIG. 5 illustrates the stitching roller and sensor assembly mounted in a transfer ring apparatus; and

FIGS. 6A and 6B illustrate a first and second example radial force measurement on a first and second green tire compared with a radial force measurement of the cured tire.

### DETAILED DESCRIPTION OF THE INVENTION

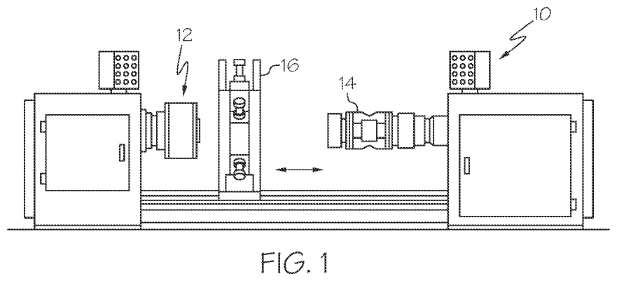

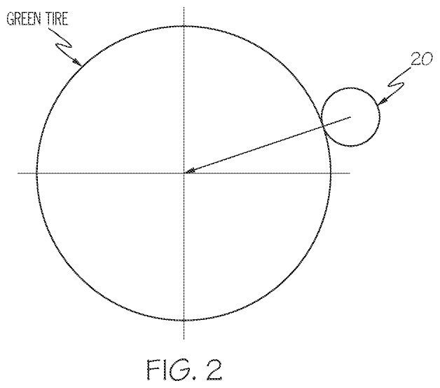

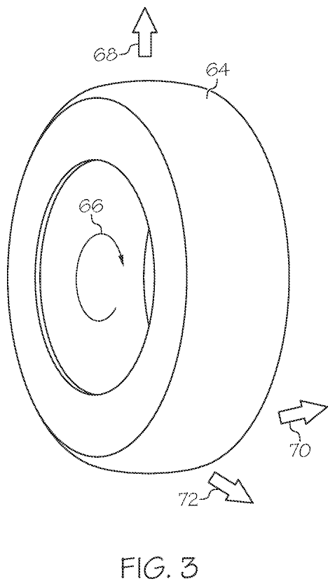

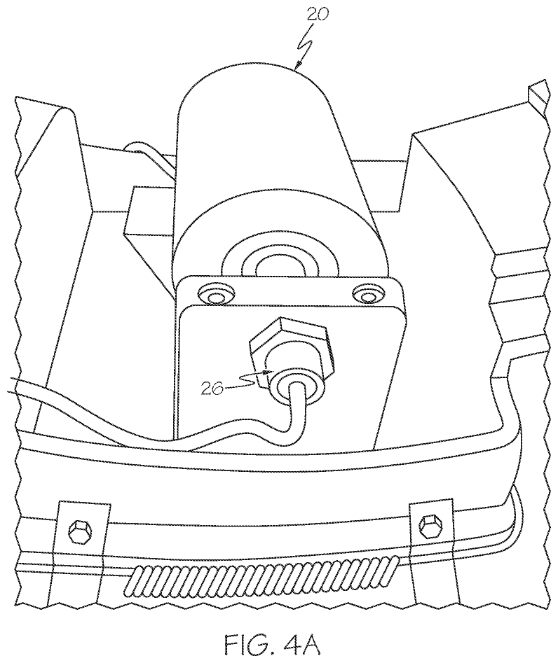

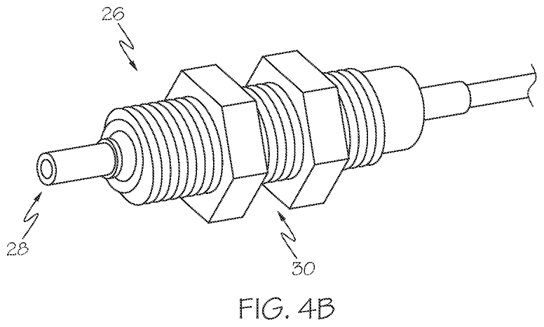

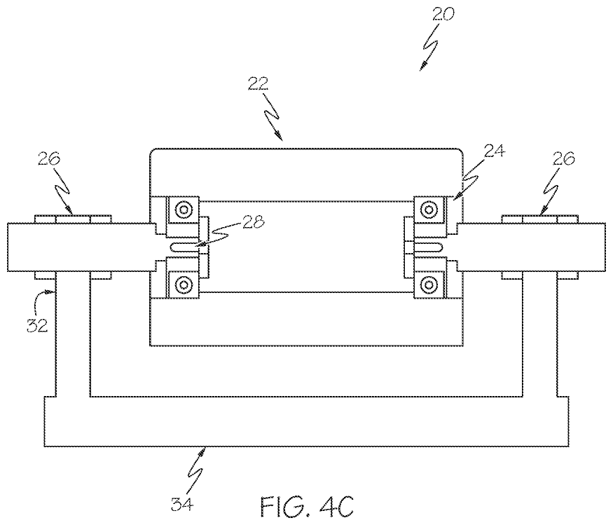

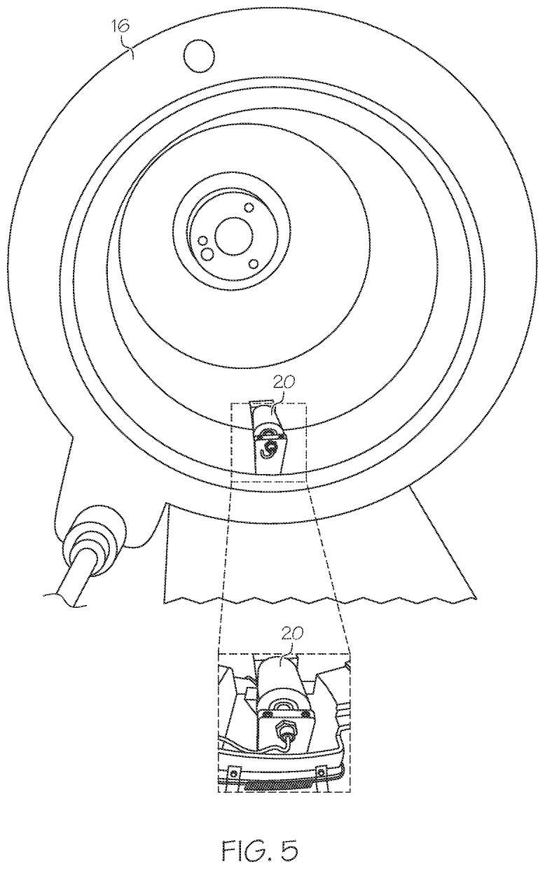

The manufacture of a pneumatic tire typically involves a tire building machine such as the one shown in FIG. 1. The tire manufacture process typically includes the steps of forming a first stage tire carcass using a tire building drum 14. Multiple layers of tire components are applied onto the tire building drum 14 to form a first stage tire carcass that is cylindrical in shape. The tire components typically include an inner liner, body ply, tire beads and sidewalls. A second tire building drum often referred to as a belt and tread or B&T drum 12 is used to form an integrated tread and belt package (hereinafter “tread ring”). A transfer ring 16 is used to pick up the tread ring from the belt drum and transfer it onto the outer circumference of the first stage carcass. The first stage carcass is then inflated into a toroidal shape inside of the belt and tread package. Next, the tread and belt package is stitched by the application of a pressure roller 20 onto the carcass. The pressure roller commonly referred to as a stitcher roller 20, functions to apply sufficient pressure to ensure that the tread and belt package is sufficiently adhered to the outer circumferential surface of the green carcass. As shown in FIGS. 4a and 5, the stitcher roller 20 may be located inside the transfer ring. Thus, the stitching operation may occur after the transfer ring has transferred the tread and belt package onto the carcass, and before the transfer ring moves back to its position. As the green tire with tread rotates on the drum 12, the stitcher roller 20 engages the tread. Measurement of the radial force occurs by the stitcher roller 20 applying a force to the tread of the uncured tire as the tire rotates.

FIG. 4C illustrates a cross-sectional view of the stitcher roller and sensor assembly 20. The stitcher roller and sensor assembly 20 includes a cylindrically shaped pressure roller 22 that is rotatably mounted on journal bearings 24 located on each end of the stitcher roll. Positioned in each journal bearing 24 is an axle sensor 26. One axle sensor suitable for use with the invention is made by Honigmann, and sold under the trade name RFS 150. Each axle sensor 26 has a spindle 28 that is mounted in the journal bearing 24 so that it rotates with the stitcher roller and is able to sense radial forces. The support end 30 of the axle sensor is mounted to a support mount 32 of the frame 34 of the stitcher roller. Thus, as the stitcher roller performs its stitching operation to apply pressure to the tread of the green tire, the axle sensors measure the radial force variation as the green tire rotates. FIG. 3 illustrates a schematic of a cured or green tire 64 undergoing rotation 66, and the direction of the radial force 68 which is in the tire's radial direction. As the tire rotates, the radial force may vary along the circumference. FIG. 3 also illustrates the lateral force 70 and aft force direction 72.

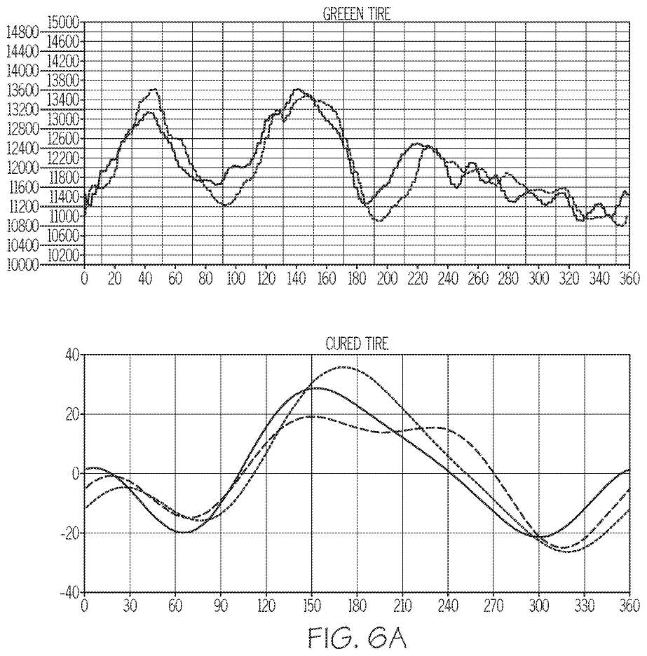

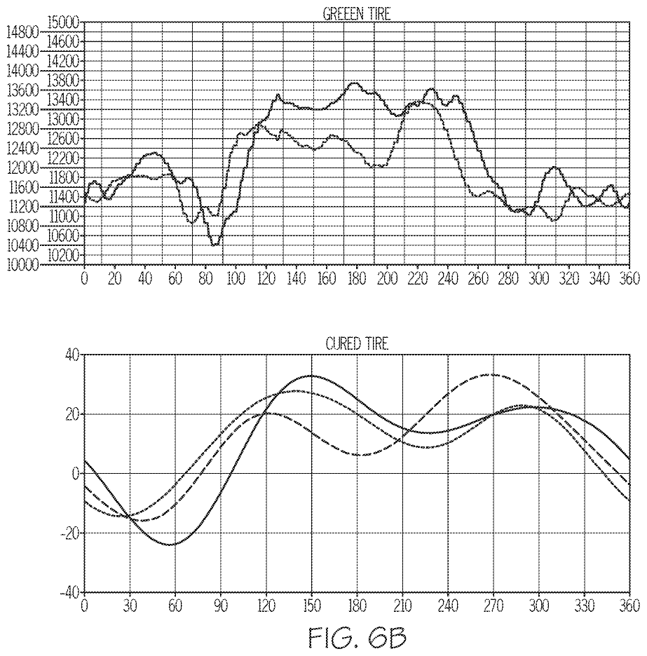

FIG. 6A and FIG. 6B illustrate experimental data of two different green tires, and the resultant radial force measurements across the centerline of the green tire. FIGS. 6A and 6B also illustrate the radial force measurements across the centerline of a cured tire. The cured tire results are comparative with the green tire results. Thus, an alert can be set should the radial force variation exceed a set threshold value, so that an operator can adjust the build properties of the tire.

While the above described stitcher roll assembly was mounted in a transfer ring, the stitcher roll assembly may be mounted in other locations, and also be a stand alone unit located adjacent to a tire building drum.

Variations in the present inventions are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A method of determining the force variation on a green tire, the method comprising the steps of: forming a green tire having a tread and belt assembly, stitching the outer surface of the tread using a pressure roller and measuring the radial force by a sensor mounted in the pressure roller.

2. The method of claim 1 wherein the radial force is measured.

3. The method of claim 1 wherein the lateral force is measured.

4. The method of claim 1 wherein the sensor is an axle sensor.

5. The method of claim 1 wherein a radial force threshold is set to a predetermined acceptable range, and a system alert is sounded when the radial force measurement is not within the acceptable range.

6. The method of claim 1 wherein a radial force threshold is set to a predetermined limit, and a system alert is sounded when the radial force measurement exceeds the limit.

7. The method of claim 5 wherein if the radial force measurement is not within the acceptable range, the tire building process is adjusted.

8. An apparatus for building tires, the apparatus comprising a tire building drum, and a stitching device, wherein the stitching device comprises a pressure roller rotatably mounted in a first and second bearing located on each end of the pressure roller, and a first and second axle sensor, each axle sensor having a spindle mounted within a respective bearing for measuring the forces on the pressure roller.

9. The apparatus of claim 8 further including a transfer ring.

10. The apparatus of claim 9 wherein the pressure roller in mounted on the transfer ring.

11. The apparatus of claim 8 wherein the axle sensor measures radial force of the pressure roller.

12. The apparatus of claim 8 wherein the axle sensor measures real time, and an alert is sent to an operator if a measured radial force exceeds a predefined limit.
